(19) United States
(12) Patent Application Publication
(10) Pub. No.: US 2014/0241558 A1
(43) Pub. Date: Aug. 28, 2014

(54) Multiple Audio Display Apparatus And Method

(71) Applicant: NOKIA CORPORATION, Espoo (FI)

(72) Inventors: Marko Tapani YLIAHO, Tampere (FI); Juha Reinhold BACKMAN, Espoo (FI)

(73) Assignee: Nokia Corporation, Espoo (FI)

(21) Appl. No.: 13/778,447

(22) Filed: Feb. 27, 2013

(51) Int. Cl. H04R 1/02

(52) U.S. Cl. CPC H04R 1/028
USPC 381/333

(57) ABSTRACT

An apparatus including at least two speakers and at least one controller. Each speaker includes at least one vibrating element, and one or more display elements. The vibrating elements are configured to at least partially move the one or more display elements to generate sound waves from the one or more display elements. The at least one controller is connected to the vibrating elements of the at least two speakers and the one or more display elements. The at least one controller is configured to control display of at least one image on the one or more display elements, and/or control driving of the vibrating elements to generate sounds from at least one of the at least two speakers.

### BACKGROUND

1. Technical Field

The exemplary and non-limiting embodiments relate generally to an apparatus and method using multiple display modules and, more particularly, to multiple display modules having individual sound generation.

2. Brief Description of Prior Developments

Flat panel displays are becoming more prevalent in devices such as televisions, computer tablets, etc. Generating sound from components located behind a front of the display is being investigated for new applications.

### SUMMARY

The following summary is merely intended to be exemplary. The summary is not intended to limit the scope of the claims.

In accordance with one aspect, an example apparatus includes at least two speakers, where each speaker comprises at least one vibrating element and one or more display elements, where the vibrating elements are configured to at least partially move the one or more display elements to generate sound waves from the one or more display elements; and at least one controller connected to the vibrating elements and the one or more display elements of the at least two speakers, where the at least one controller is configured to control display of at least one image on the one or more display elements and/or control driving of the vibrating elements to generate sounds from at least one of the at least two speakers.

In accordance with another aspect, an example method comprises generating a first sound from a first speaker, where the first sound is generated by a first vibrating element at least partially moving a first display element of at least one display element; generating a second sound from a second speaker, where the second sound is generated by a second vibrating element at least partially moving the first display element or a second display element of the at least one display element; and controlling the vibrating elements such that the first sound and the second sound are at least partially independently generated.

In accordance with another aspect, an example non-transitory program storage device is provided readable by a machine, tangibly embodying a program of instructions executable by the machine for performing operations, where the operations comprise generating a first sound from a first speaker, where the first sound is generated by a first vibrating element at least partially moving a first display element of at least one display element; and generating a second sound from a second speaker, where the second sound is generated by a second vibrating element at least partially moving the first display element or a second display element of the at least one display element, where the first sound and the second sound are at least partially independently generated.

### BRIEF DESCRIPTION OF THE DRAWINGS

The foregoing aspects and other features are explained in the following description, taken in connection with the accompanying drawings, wherein:

FIG. 1 is a front view of an example embodiment;

FIG. 2 is a schematic diagram illustrating some of the components of the apparatus shown in FIG. 1;

FIG. 3 is a schematic sectional view of one of the audio display modules shown in FIG. 1;

FIG. 4 is a schematic cross sectional view of an example embodiment comprising features as described herein;

FIG. 5 is a partial enlarged view of a portion of the example shown in FIG. 4;

FIG. 6 is a perspective view illustrating another example embodiment;

FIG. 7 is a view illustrating another example embodiment;

FIG. 8 is a view illustrating another example embodiment;

FIG. 9 is a view illustrating another example embodiment;

FIG. 10 is a front view illustrating a use example of the apparatus shown in FIG. 1;

FIG. 11 is a front view of another example embodiment illustrating another use case of features;

FIGS. 12 and 13 are front views of the apparatus shown in FIG. 1 illustrating switching locations of participants' images and sounds in a teleconference type of use case;

FIG. 14 is an exploded side view illustrating another example embodiment of components of an audio display module;

FIG. 15 is a diagram illustrating some features of an example method;

FIG. 16 is a front view of another example embodiment comprising features as described herein;

FIG. 17 is a diagram illustrating an example embodiment comprising a flexible display element;

FIG. 17A is a diagram illustrating an example embodiment comprising a flexible display element;

FIG. 18 is a diagram illustrating an example embodiment where one vibrating element is used to move two display elements;

FIG. 19 is a diagram illustrating an example of groups of vibrating elements and display elements;

FIG. 20 is a diagram illustrating a vibrating element located in front of a display element;

FIG. 21 is a perspective view of a stand which may be used to hold a speaker as described herein;

FIG. 22 is a holder which may hang a speaker as described herein;

FIG. 23 is a diagram illustrating a window having features as described herein;

FIG. 24 is a schematic diagram illustrating some alternative components of the apparatus shown in FIG. 1;

FIG. 25 is a schematic diagram similar to FIG. 24 showing another example embodiment;

FIG. 26 is a schematic diagram similar to FIG. 24 showing another example embodiment;

FIG. 27 is a diagram illustrating another example embodiment.

### DETAILED DESCRIPTION OF EMBODIMENTS

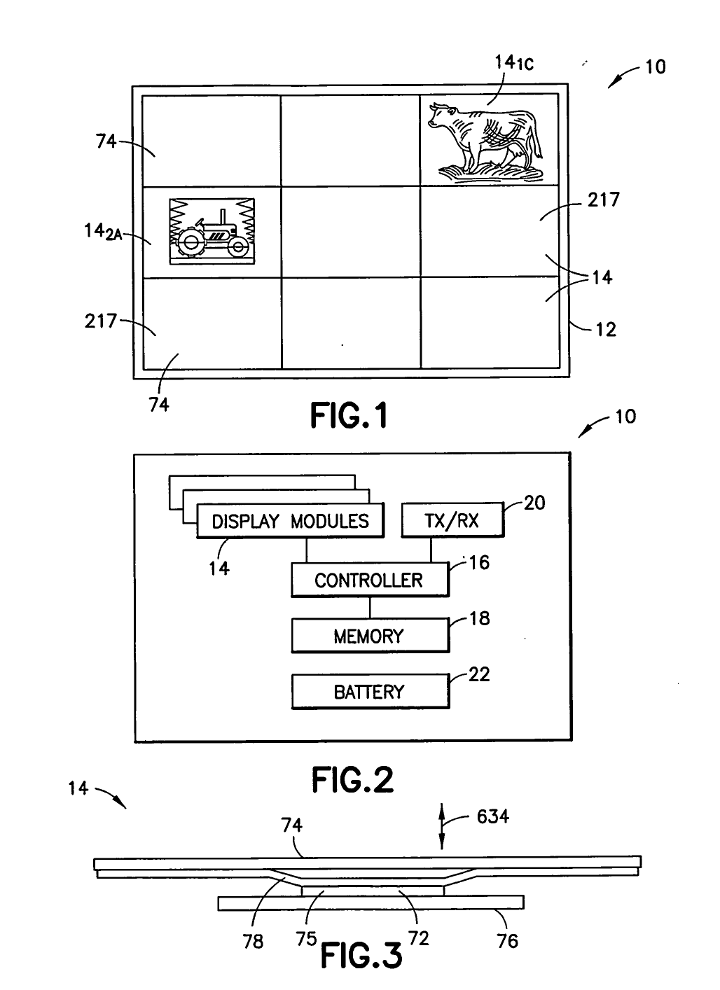

Referring to FIG. 1, there is shown a front view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

The apparatus 10 in this example is a computer tablet. However, in alternate examples the apparatus might comprise any suitable apparatus having a display as further understood from the description below. In this example the tablet 10 comprises a housing 12 and, referring also to FIG. 2, electronic circuitry including audio display modules 14, a controller 16, memory(ies) 18, a transmitter and receiver 20, and a rechargeable battery 22. The apparatus may comprise additional components. The controller 16 may comprise a processor on a printed wiring board for example. In this example the tablet 10 comprises nine of the audio display modules 14. However, in alternate examples more or less than nine audio display modules may be provided.

Referring also to FIG. 3, each of the audio display modules 14 comprises a speaker 70 comprising a vibrating element 72 and a display element 74. In this example the vibrating element 72 comprises a piezoelectric member 75 connected to a printed circuit board 76. The display element 74 is an electronic display. A member 78 connects the piezoelectric member 75 to the back side of the display element 74. The piezoelectric member 75 is flexed by the printed circuit board 76. This causes the piezoelectric member 75 to move the electronic display 74 in and out as illustrated by arrow 634 to generate sound waves from the front of the electronic display 74.

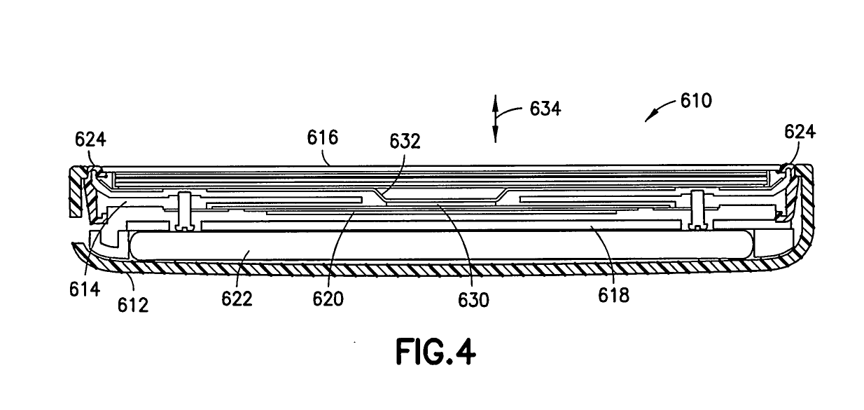

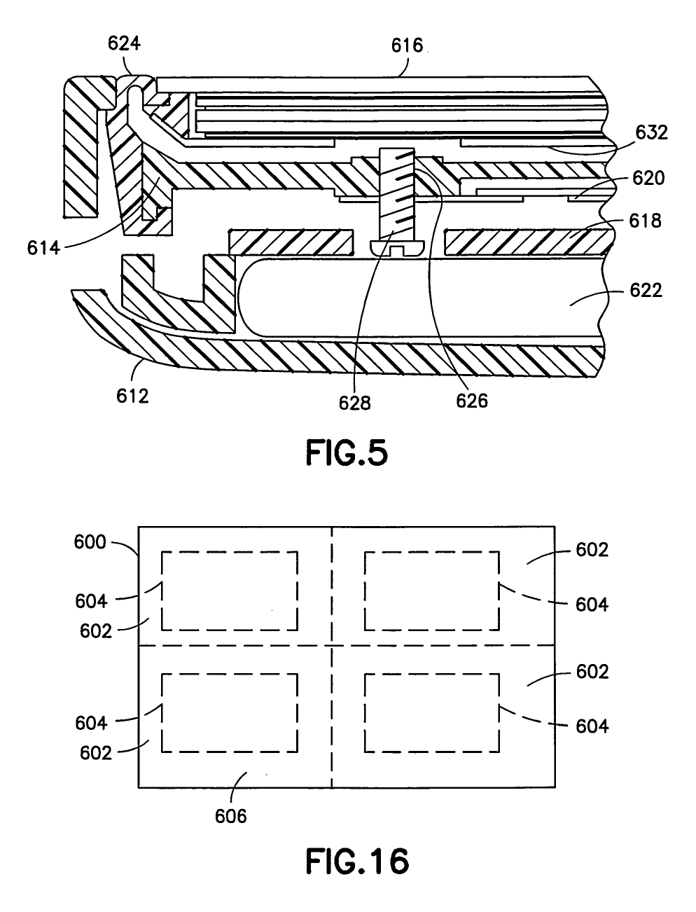

Referring also to FIGS. 4-5 another example is shown. In this example the apparatus 610 comprises a body 612, a chassis 614, an electronic display 616, an engine printed wiring board (PWB) 618, an audio transducer comprising a piezoelectric member 620, and a battery 622. The electronic display 616 is connected to the chassis by a flexible member 624. Thus, the electronic display 616 is able to move in and out relative to the chassis with the flexible member deflecting. Ends 626 of the piezoelectric member are fastened to the chassis by screws 628. The center of the piezoelectric member is connected to the back side of the electronic display 616 by a gasket 630 and a display frame 632. The piezoelectric member 620 is flexed by the PWB 618. This causes the piezoelectric member 620 to move the electronic display 816 in and out as illustrated by arrow 634 to generate sound waves from the front of the electronic display 616.

Features as described herein may fundamentally utilize implementation of an “Audio Display” concept which has been developed by Nokia Corporation. In the Audio Display concept, generally, at least one piezo actuator may be suitably coupled to the display module for sound generation so that the display module can be used as a conventional display, but further for sound generation and tactile feedback. In alternative embodiments of Audio Display integrations, the piezo actuator may be coupled to the display window (in front of the display module) for sound generation. There are various ways of reproducing sound waves in the direction of the display module.

Referring back to FIG. 1, each audio display module 14 is configured to function as a display and also function as a speaker or sound transducer. FIG. 1 shows a tablet device that has a 3×3 matrix of separately controllable audio displays 14. FIG. 1 shows an image of a tractor being displayed on display module 14_{2A} and an image of a cow mooing being displayed on audio display module 14_{1C}. The sound of a tractor may be generated by the audio display module 14_{2A}. The sound of a cow mooing may be generated by the audio display module 14_{1C}. The directions of the two different sounds, coming from the respective audio display modules, can be easily recognized by the user holding the tablet 10.

The tablet has nine of the audio display modules 14 in this example. Thus, sounds may be generated from each of the audio display modules. Each audio display module is configured to display an at least partially different image, and generate an at least partially different sound. In some use cases, the sounds generated from two or more of the audio display modules may be the same, and the image displayed on two or more of the audio display modules may be the same. In addition, another example embodiment may comprise more or less than nine audio display modules. One or more display elements which does not have a vibrating element to form a speaker may be provided in an apparatus with one or more of the audio display modules 14.

As seen in FIG. 2, the audio display modules 14 are connected to the controller 16. The controller 16 is configured to control display of images on the individual display elements 74, and also control generation of sound from the individual audio display modules 14. The source of the images and sounds may comprise any suitable source(s), such as applications, video, data from the Internet, television signals, etc. The audio signals sent to the individual audio display modules 14 may be formed or controlled by the controller. For example, the controller 16 may control sending a first track of a multi-trace audio signal to only a first one of she audio display modules and a different second track of the multi-track signal to only a second different one of the display modules. As another example, when the controller displays different portions of a single image on respective ones of the audio display modules, the controller may be configured to send at least partially different audio signals to the different audio display modules which are based upon a same input audio signal. For example, left and right channels may be downmixed with different percentages into different mono signals corresponding to location of the audio display modules relative to left and right positions of the audio display modules.

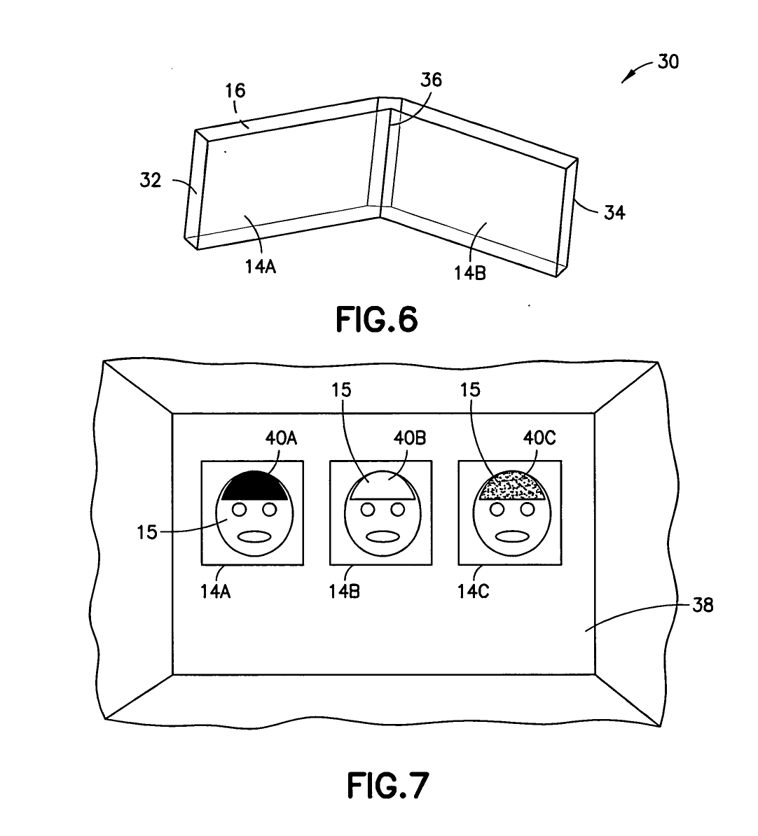

FIG. 6 is a schematic diagram of another example embodiment. In this example the apparatus 30 is a portable hand-held electronic device, such as a hand-held electronic game or a smart phone. The apparatus 30 comprises a first section 32 and a second section 34. The first and second sections 32, 34 are movable connected to each other, such as by a hinge 36. The first section 32 comprises a first audio display module 14A. The second section 34 comprises a second audio display module 14B. The controller 16 of the apparatus 30 may be configured to send a left channel audio signal to the first audio display module 14A and a right channel audio signal to the second audio display module 14B. Thus, even though the individual audio display modules 14 are only able to produce mono-only sound, the apparatus 30 as described above can provide stereo audio sound. The apparatus 30 is a stereo audio display device,

Apparatus 30 may be a clamshell phone where both the flip and the chassis have Audio Displays 14. When the device is put sideways, the first audio display module 14A could play the left channel and the second audio display module 14B could play the right channel. This would be even better if the device can open more than 180 degrees. In one example embodiment, the choice to play different channels from different audio display modules could be done using an accelerometer or a gyroscope. If the apparatus 30 notices that it is orientated sideways, it may be able to automatically do this for stereo audio. The stereo image could be enhanced using stereo widening algorithms. In one example embodiment parameters for stereo widening may depend on the angle of the device when open.

The same principals may be applied to other form factors with two separate display stacks such as, for example, sliders with two displays like a landscape slider, a portrait slider and a tilt slider.

Features as described herein may be used to provide an extended User Interface (UI) control. It could be that both physical speaker elements would provide possibilities to adjust the audio signal specifically for that channel. This would be quite intuitive as both speakers also work as touch displays. In one example embodiment, a graphic equalizer may be provided separately for both speakers. In another example embodiment, a balance UI may be provided on each audio display module. This may provide very intuitive balance setting by the user because it is adjusted directly by touching the speaker. In another example embodiment, stereo widening or surround sound virtualizer strength setting for loudspeakers may be provided as the UI. The effective strength can be adjusted directly on the speaker by changing a size of a “bubble” image for example.

Features as described herein may be used with telephony and more than one audio channel. With this concept teleconferencing can be implemented so that, in a stereo telephony speakerphone use case such as in FIG. 6, we can spatially separate the human speakers. The sound from a first person could come from the first audio display module 14A and the sound from a second person could come from the second audio display module 14B. Their virtual locations can be also visually represented in the two audio display modules 14A, 14B, respectively. This can fully support everything that has been implemented/designed for headset teleconferencing, but now without the need for a headset. Even two mics for stereo telephony would be available without a special accessory.

The difference compared to a “conventional” stereo speaker device is that traditionally the display is between the speakers, but in the stereo audio display case using the audio display modules 14 the speakers are the display. The location of the persons in sound space is more intuitive.

Benefits of features as described herein are stereo image using mono-only audio display modules, more loudness because there are two or more speakers, intuitive settings as the speakers have touch input, spatial separation of the far-end human speakers in the speakerphone use case, and a concept for a speaker array.

Referring also to FIG. 7, an array of the audio display modules 14 are shown at the home of the user hanging on the living room wall 38. The array may be used, for example, for video telephony conference rendering images 40A, 40B and 40C of the remote participants and/or the user at the home. A separate controller 16 may be connected to the respective audio display modules 14, and/or the audio display modules 14 may have their own internal controllers which are connected to each other to perhaps work together. The sound from the first participant illustrated in the first image 40A would come from the front 15 of the first image 40A. The sound from the second participant illustrated in the second image 40B would come from the front 15 of the second image 40B. The sound from the third participant illustrated in the third image 40C would come from the front 15 of the third image 40C.

The audio display modules 14 may be physically connected such as, for example, a housing 12 as shown in FIG. 1. The audio display modules may be logically connected such as, for example, shown in FIG. 7. In the example shown in FIG. 7, the audio display modules 14 are separately mounted to the wall 38. The audio display modules 14 are operably associated with each other to provide audio/video teleconferencing which may be controlled by a separate controller (not shown) merely using the audio display modules 14 as separate displays for each participant and as separate respective audio transducers for each participant's audio signal, where the sound for each participant emanates from the front 15 of the image 40 corresponding to that participant.

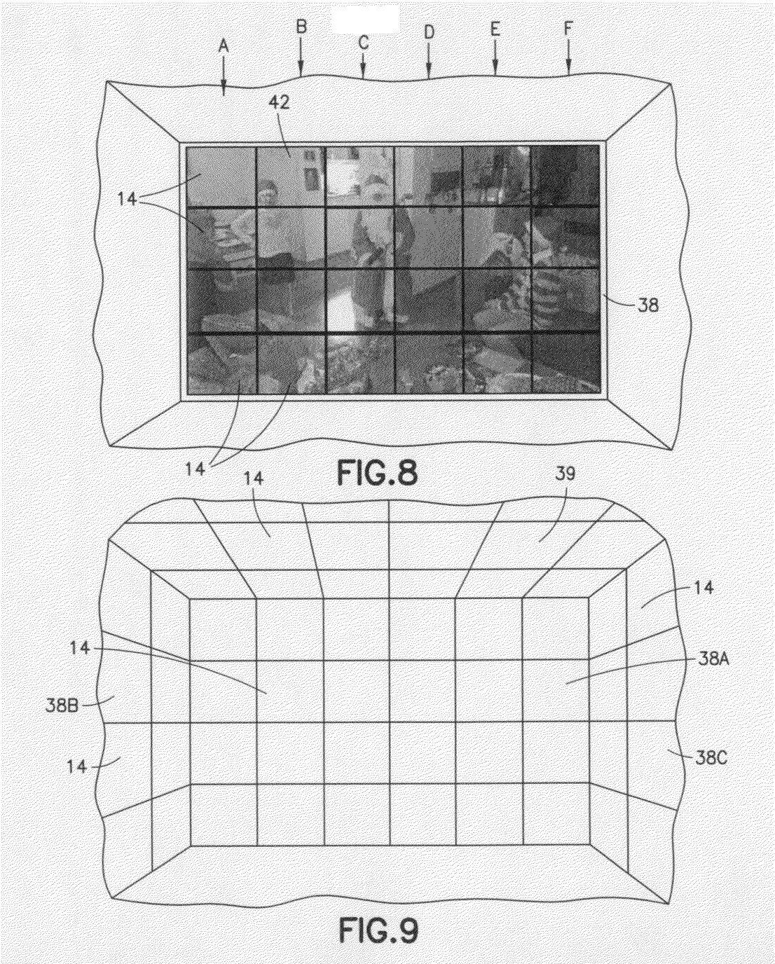

Referring also to FIG. 8, another example embodiment is shown. In this example a matrix of audio display modules 14 at the home of the user on the living room wall 38 is provided working as a TV or similar display. In this example embodiment the apparatus comprises an array of 4×6 of the audio display modules 14. A separate controller 16 may be connected to the respective audio display modules 14, and/or the audio display modules 14 may have their own internal controllers which are connected to each other to perhaps work together. The connection may be wired or wireless to each other and/or to a set-top box for example. Different portions of a single image 42 are displayed on respective different ones of the audio display modules.

The sound generated from each of the audio transducers may be the same, or may be at least partially different in at least some of the audio display modules. For example, if the audio signal being played is a stereo audio signal having a left channel and a right channel, the left channel may be played on the audio display modules in columns A, B and C, and the right channel may be played on the audio display modules in columns D, E and F. In alternate example uses or embodiments, various mixing and/or appointment of the audio display modules 14 to play specific audio signals could be provided and designated, at least partially, by the controller(s).

Referring also to FIG. 9, another example embodiment is shown. In this example walls 38A, 38B, 38C and a ceiling 39 are covered with audio display modules 14. This might be provided, for example, in a movie theater. A grid is shown without a picture in it to avoid too much complexity. Even with conventional object based audio systems such as DOLBY ATMOS, she screen is in the front and, although there are speakers on the sides, on the back and even above the customer, there is visual content only in the front. Thus, with a conventional DOLBY ATMOS system if there is a helicopter flying towards and then above the movie goer, the movie goer can see the helicopter only when it is coming towards the movie goer from the front screen; not when it is above because there is no display above. As soon as the helicopter is above the movie goer, there is only sound. Features as illustrated by FIG. 9 provide a method and apparatus where objects in a movie may both appear and play sound from a same direction for more than one direction. This may be provided with flat walls/ceiling, so curved walls/ceiling are not necessary (but still may be used). This may be provided with walls which are directly opposite each other, such as walls 38B and 38C, or walls which are perpendicular, such as wall 38A and ceiling 39. Benefits over conventional speakers include:
With object based audio, computational load is significantly smaller compared to virtual solutions where there are conventional speakers in certain locations and audio rendering must be calculated for that specific set of speakers; and
A more natural audio experience independent of the seat in the movie theater. When it comes to object based audio, virtualization works optimally only in a subset of the theater seats (or one might say that it does not work optimally anywhere), but this solution provides truly localized audio no matter where the consumer sits in the theater.

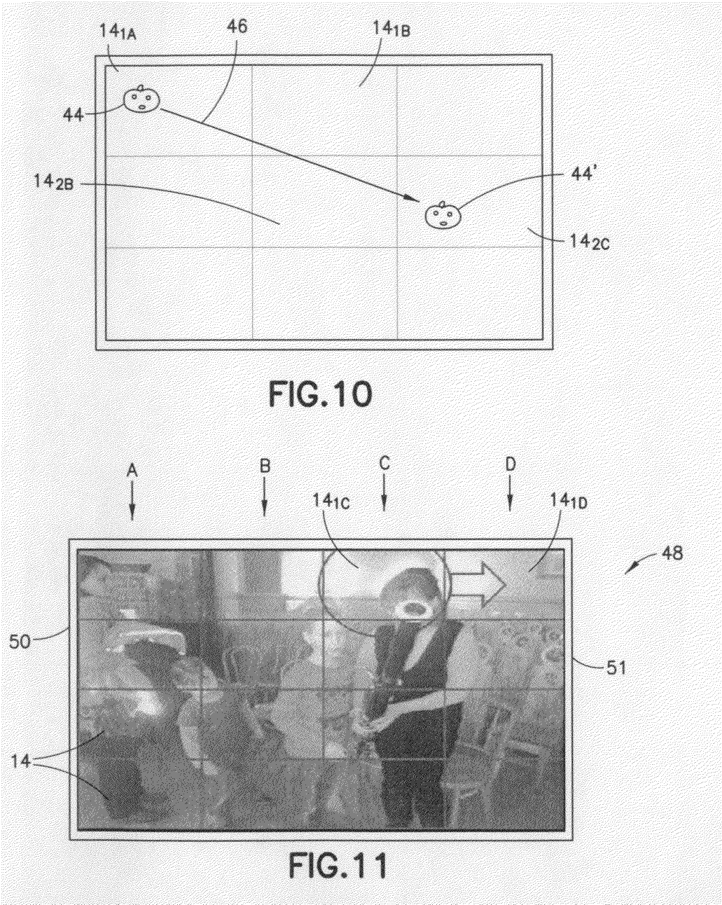

Referring also to FIG. 10, drag and drop of an icon 44 in an operating system main screen may give audio feedback from the direction where the icon was grabbed at audio display module 14_{1A}, subsequently from along the direction where the icon has been dragged 14_{1A}, 14_{1B}, 14_{2B}, 14_{2C}, and from the direction where the icon is the dropped 14_{2C} as illustrated by arrow 42 and icon 44′. Each of the audio display modules 14 acts as a speaker. Benefits over conventional speakers include:
Two conventional speakers cannot provide a localized audio in a y-axis; and
Localized audio with conventional speakers in x-axis is provided practically using a balance feature.

Referring also to FIG. 11, an example embodiment is shown to illustrate physical stereo widening. In this example the apparatus 48 comprises a 4×4 array of the audio display modules 14. Sound objects playing in the middle audio displays (columns B and C) of the full screen may be played on those middle audio displays and on the audio display modules (columns A and C) closer to the device lateral side ends 50, 51. This can be easily done, for example, when rendering movie content having object based audio. In the example shown in FIG. 11, sound from the musical instrument may be played on both audio display 14_{1C} and 14_{1D} to provide stereo widening. A benefit over conventional speakers includes that computational stereo widening with conventional speakers works only in a narrow sector, while truly physical stereo widening, as illustrated by this example embodiment, works in any listening position.

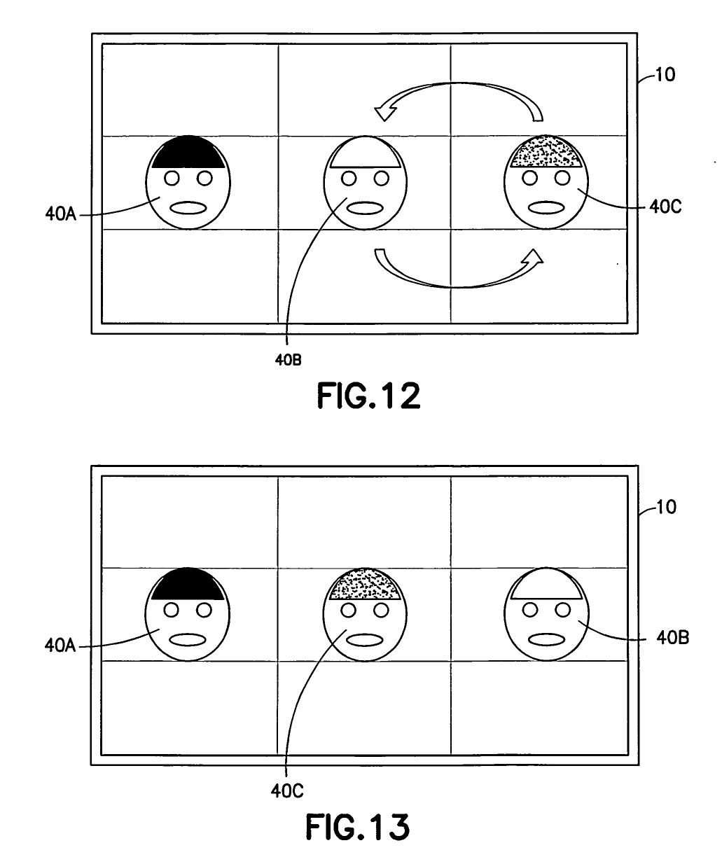

Referring also to FIGS. 12 and 13, video teleconference using a tablet having a matrix of audio displays is shown. The participants' virtual places can be changed by dragging and dropping, and the user actually can thus select from which direction everybody's voice actually physically comes from. Benefits over conventional speakers include:
Due to physical audio localization, computational load is zero compared to virtual solutions; and
Virtual solution works only in a narrower sector, while truly physical audio localization works in any listening position.

Features as described herein may be used to provide localized audio playback using multiple physically or logically associated Audio Displays. The direction of sound from a single speaker is extremely difficult to control. Thus, only physically separate speakers can provide truly directional audio playback. When the speakers are panel or panel-like speakers providing also display functionality, the sound of virtual objects shown in the displays can concretely have a direction where they play from depending on which display they are shown on and playing.

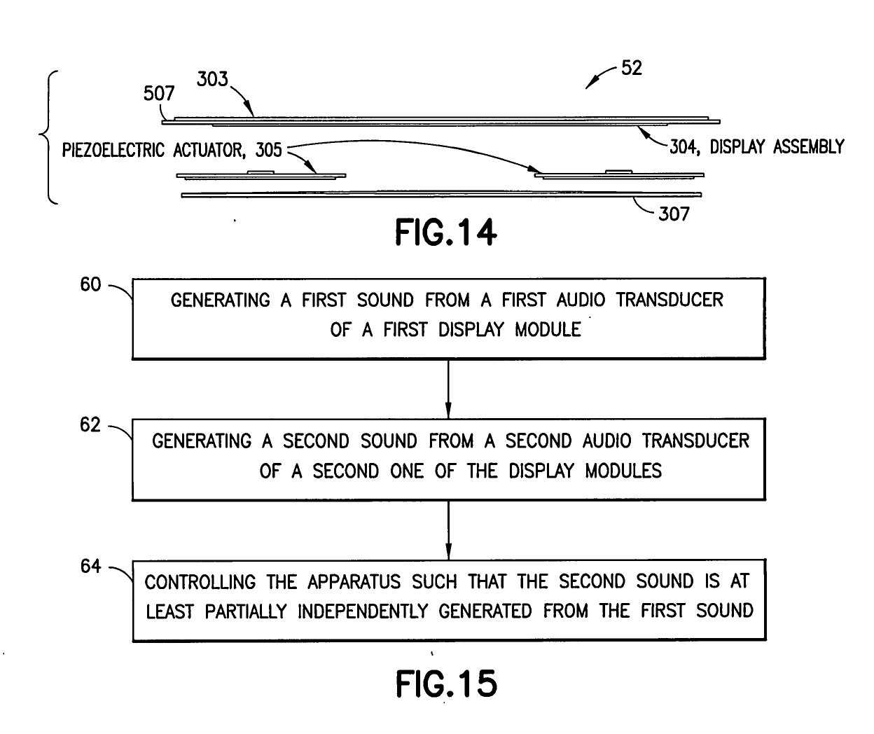

As noted above, the constructions shown in FIGS. 3-5 are merely example embodiments which may be used. Other audio display constructions could be provided. Referring also to FIG. 14, an exploded view of another example is shown comprising a display assembly 304, covered by a window plate 303, a printed circuit board 307, and two piezoelectric actuators 305. In this example the audio display module 52 is configured to provide an electronic display feature, an audio speaker feature and a haptic feedback feature.

The display 304 may be configured to employ a flexible membrane or plate suspension membrane 507. The flexible membrane 507 may be located in contact or substantially in contact with a rubber force contact and suspended, at least partially, at a periphery of the flexible membrane 507 between a frame part 301 and a body part (not shown). The flexible membrane 507 may be sandwiched at the periphery of the membrane between the body part and the frame part.

The display assembly 304 may comprise a display element, such as an LCD display element for example. The display element may comprise a static display array located beneath the front window 303 and projected up to the user through the front window 303.

The display assembly 304 in some embodiments may comprise a touch sensor such as, for example, a capacitive touch sensor located over the display element. The capacitive touch sensor may comprise a series of layers. The layers in the capacitive touch sensor can comprise at least one Indium Tin Oxide on PET layer, and a protective hard coated PET layer.

The flexible membrane 507 can be, in some embodiments, considered to be a laminar film or layer which is located at least at some contact area to an inner part comprising at least one of the window, touch sensor and display element and at least at some other contact area to the outer part comprising at least one of the frame or body part. The flexible membrane 507 furthermore in these embodiments maintains a flexible connection between the inner part and the outer part. In other words the flexible membrane 507 is configured in these embodiments to be flexible in that it is elastic in nature such that when pressure is applied to the front window 303 the flexible membrane 507 can move or flex relative to the frame or body part and, thus, the inner part can move relative to the outer part.

The flexible membrane 507 is preferably light and does not therefore produce significantly more undamped weight in addition to the mass of the suspended display assembly to be moved by the piezoelectric actuator 305. In some embodiments the elasticity or flexibility of the flexible membrane 507 is such that it enables a vertical or sheer displacement of the display assembly with respect to the body part and frame part such that the user experiences a response similar to that of pressing a physical key or button.

The piezoelectric actuator 305 may be modulated in such a way that the modulation transmitted via the flexible membrane laminar to the display 304 causes the display 304 to generate audible oscillations. In other words the display can be used as a flat panel speaker structure where the flexible membrane 305 provides sufficient damping (but not under-damping or over-damping) in the transmission of the piezoelectric actuated vibration to the display assembly 304.

The front window 303 may be smaller than the display assembly 304 (which would in thus example include the flexible membrane and suspension ring) such that the display assembly flexible membrane can be located between the frame part and the body part. The front window 303 in such embodiments lies over or is in contact with the display assembly 304. In such embodiments the piezoelectric actuators 305 are configured to be in contact with the display assembly 304 via, for example, the rubber force contacts.

An example Audio Display with features has described herein may comprises a case (such as a unibody or such as a conventional mechanical chassis having a side band and back cover), a display configured to display an image, at least one vibrating element (such as a piezo for example) configured to actuate the display to move the display relative to the case to generate acoustic waves, and a gasket (movable connector)) interfacing the case and the display.

Features as described herein relate to audio provided by panel speakers that also include a display i.e. an Audio Display. And, more specifically, features comprise using multiple physically or logically connected Audio Displays. A problem with an Audio Displays is that it can only generate mono sound. Features as described herein provide a means for making localized audio by using multiple Audio Displays.

The direction of sound from a single speaker is extremely difficult to control. Thus, only physically separate speakers can provide truly directional audio playback. When the speakers are panel or panel-like speakers providing also display functionality, the sound of virtual objects shown in the displays can concretely have a direction where they play from depending on which display they are shown and playing.

A monoblock design, such as shown in FIG. 14 for example, does not provide good stereo image by itself; even if different audio signal would be played with both piezos 305. The reason for this is because there is still just one panel; the display assembly 304. However, with two or more separate panels playing audio, non-mono audio may be provided.

One type of example apparatus may comprise at least two display modules, where each of the display modules comprises an electronic display and an audio transducer, where the audio transducer is configured to generate sound waves by the display module in a direction from the front of the electronic display; and a controller connected to the display modules, where the controller is configured to display at least partially different images on the electronic displays and, perhaps, cause the audio transducers to generate at least partially different sounds from the audio transducers.

The apparatus may be a computer tablet having the display modules at least partially form a display of the computer tablet. The apparatus may comprise a frame having a first section with a first one of the display modules and a second section with a second one of the display modules, and where the first section is movably connected to the second section. The at least two display modules may be configured to be separately connected to a wall of a room. The at least two display modules may be configured to be separately connected to at least two different walls of the room or at least one wall and a ceiling of the room. The at least two display modules may be configured to be connected to a wall of a room adjacent each other. The audio transducer of each of the display modules may be a sole audio transducer of the respective display module. The controller may be configured to change an incoming audio signal into different audio signals sent to the respective different audio transducers based upon the different images displayed on the respective electronic displays. The controller may be configured to send a first channel of a multi-channel audio signal (such as stereo for example) to a first one of the display modules and to send a second channel of the multi-channel audio signal to a second one of the display modules, where the first display module only receives the first channel and the second display module only receives the second channel. The controller may be configured to send a first audio/video signal to a first one of the display modules and a different second audio/video signal to a second one of the display modules. The controller may be configured to switch sending of the first audio/video signal to the second display module and the different second audio/video signal to the first display module. The controller may be configured to transition generating of sound from a first one of the display modules to a second one of the display modules as an image moves from the electronic display of the first display module to the electronic display of the second display module. The at least two display modules may comprise middle ones of the display modules and edge ones of the display modules on opposite sides of the middle ones, where the controller is configured to provide stereo widening where audio corresponding to an image in at least one middle one of the display modules is played on at least one of the edge display modules. The apparatus may comprise means for providing non-mono sound with multiple mono-only display modules.

Referring also to FIG. 15, an example method may comprise generating a first sound from a first audio transducer of a first display module as indicated by block 60, where the first display module is one of a plurality of display modules of an apparatus, where the first sound is generated from a front of a first electronic display of the first display module; generating a second sound from a second audio transducer of a second one of the display modules as indicated by block 62, where the second sound is generated from a front of a second electronic display of the second display module; and controlling the apparatus such that the second sound is at least partially independently generated from the first sound as indicated by block 64.

Controlling the apparatus may comprise changing an incoming audio signal into different audio signals sent to the respective audio transducers based upon different images displayed on the respective electronic displays. Controlling the apparatus may comprise sending a first channel of a multi-channel audio signal to the first display module and sending a second channel of the multi-channel audio signal to the second display module, where the first display module only receives the first channel and the second display module only receives the second channel. Controlling the apparatus may comprise sending a first audio/video signal to the first display module and a different second audio/video signal to the second display module. Controlling the apparatus may comprise switching sending of the first audio/video signal to the second display module and the different second audio/video signal to the first display module. Controlling the apparatus may comprise transition generating of sound from the first display module to the second display module as an image moves from the first electronic display to the second electronic display. Controlling the apparatus may comprise the controller providing stereo widening where audio corresponding to an image in at least one middle one of the display modules is played on at least one edge one of the display modules.

In another example a non-transitory program storage device readable by a machine may be provided, such as in memory 18 for example, tangibly embodying a program of instructions executable by the machine for performing operations, the operations comprising: generating a first sound from a first audio transducer in a first display module, where the first display module is one of a plurality of display modules of an apparatus, where the first sound is generated by a first electronic display of the first display module; and generating a second sound from a second audio transducer in a second one of the display modules, where the second sound is generated by a second electronic display of the second display module, where the second sound is at least partially independently generated from the first sound.

One type of example apparatus may comprise at least one display module and a controller. The at least one display module comprises at least one electronic display and at least two audio transducers. The at least one display may comprise a portion of the at least two transducers. The audio transducers are configured to at least partially move the at least one electronic display to generate sound waves from the at least one display module. The controller is connected to the at least one display module, where the controller is configured to control display of at least one image on the at least one electronic display and control driving of the at least two audio transducers, at least partially, independently, to generate sounds from the audio transducers.

An example method may comprise generating a first sound from a first audio transducer in at least one display module, where the first sound is generated by the first audio transducer at least partially moving a first electronic display of the at least one display module; generating a second sound from a second audio transducer in the at least one display module, where the second sound is generated by the second audio transducer at least partially moving the first electronic display or a second electronic display of the at least one display module; and controlling the apparatus such that the first sound and the second sound are at least partially independently generated.

Another example may comprises a non-transitory program storage device, readable by a machine, tangibly embodying a program of instructions executable by the machine for performing operations, where the operations comprise generating a first sound from a first audio transducer in at least one display module, where the first sound is generated by the first audio transducer at least partially moving a first electronic display of the at least one display module; and generating a second sound from a second audio transducer in the at least one display module, where the second sound is generated by the second audio transducer at least partially moving the first electronic display or a second electronic display of the at least one display module, where the first sound and the second sound are at least partially independently generated.

In one example embodiment, features as described herein could be implemented using separate display modules. However, such as shown in FIG. 16, it is also possible that a single display module 600 could be divided into segments 602, such as a matrix or grid like elements, wherein each element could be used for sound generation. In particular, each segment 602 could have a vibrating element 604 which each work with the single electronic display 606 of the same display module 600. However, using separate displays mechanically and acoustically would have better separations.

In one type of example embodiment at least two displays can possibly generate the same sounds. The at least two displays can display the same visual content. Different elements/modules can show the same image and play the same sound, so the sounds do not have to be at least partially different.

Random-like polar patterns of vibrating panels make combining multiple sound sources easier from an interference point of view. Also, the frequency response and loudness of the vibrating panels can be less affected by proximity of other devices, as there are no ports etc. to block.

Features as described herein provide a solution wherein the display modules have been associated with respective audio channels so as to drive the display elements independently (and able to independently display respective visual contents when desired). This is different from known systems comprising a display screen in front of multiple speakers where the display is not controlled or divided. Features as described herein can be used for portable electronic devices and possibly the implementation possibilities can be extended towards TVs, computer monitors, digital picture frames, etc. Features as described herein can provide a better spatial audio perception in example use cases. Because display modules are able to be controlled independently, features as described herein can provide a better spatial separation between the sound sources, but said sound sources can be acoustically coupled towards improved loudness in other use cases.

An example embodiment may comprise at least two speakers, where each speaker comprises at least one vibrating element, where the at least two speakers comprise at least one display element, where the vibrating elements are configured to at least partially move the at least one display element to generate sound waves from the at least one display element; and a controller connected to the vibrating elements of the at least two speakers and the at least one display element of the at least two speakers, where the controller is configured to control display of at least one image on the at least one display element and control driving of the vibrating elements to generate sounds from the at least two speakers.

The at least two speakers may comprise at least two display modules, where each display modules comprises a separate one of the display elements, and where each of the display modules each comprise a separate one of the vibrating elements in each of the display modules. The apparatus may be a computer tablet having the at least one display element at least partially form a display of the computer tablet. The apparatus may comprise a frame having a first section with a first one of the speakers and a second section with a second one of the speakers, and where the first section is movably connected to the second section. The at least two speakers may comprise at least two display modules which are configured to be separately connected to a wall of a room. The at least two display modules may be configured to be separately connected to at least two different walls of the room or at least one wall and a ceiling of the room. The at least two speakers may comprise at least two display modules which are configured to be connected adjacent each other to a wall of a room. The vibrating element of each of the speakers may be a sole vibrating element of a respective display module. The controller may be configured to change an incoming audio signal into different audio signals sent to the respective different vibrating elements based upon the different images displayed on the respective display elements. The controller may be configured to send a first channel of a multi-channel audio signal to a first one of the vibrating elements and to send a second channel of the multi-channel audio signal to a second one of the vibrating elements, where the first display module only receives the first channel and the second display module only receives the second channel. The controller may be configured to send a first audio/video signal to a first one of the speakers and a different second audio/video signal to a second one of the speakers. The controller may be configured to switch sending of the first audio/video signal to the second speaker and the different second audio/video signal to the first speaker. The controller may be configured to transition generating of sound from a first one of the speakers to a second one of the speakers as an image moves from the at least one display element at the first speaker to the at least one display element at the second speaker. The at least two speakers may comprise middle ones of the speakers and edge ones of the speakers on opposite sides of the middle ones, where the controller is configured to provide stereo widening where audio corresponding to an image at the at least one display element proximate the middle ones is played on the edge ones of the speakers. The apparatus may comprise means for providing non-mono sound with multiple mono-only vibrating elements.

An example method may comprise generating a first sound from a first speaker, where the first sound is generated by a first vibrating element at least partially moving a first display element of at least one display element; generating a second sound from a second speaker, where the second sound is generated by a second vibrating element at least partially moving the first display element or a second display element of the at least one display element; and controlling the vibrating elements such that the first sound and the second sound are at least partially independently generated.

Controlling the vibrating elements may comprise changing an incoming audio signal into different audio signals sent to the respective vibrating elements based upon different images displayed on the at least one display element proximate the respective vibrating element. Controlling the vibrating elements may comprise sending a first channel of a multi-channel audio signal to a first one of the vibrating elements and sending a second channel of the multi-channel audio signal to a second one of vibrating elements, where the first vibrating element only receives the first channel and the second vibrating element only receives the second channel. Controlling the vibrating elements may comprise sending a first audio/video signal to a first display module comprising the first vibrating element and the first display element and a different second audio/video signal to a second display module comprising the second vibrating element and the second display element. Controlling the vibrating elements may comprise switching sending of the first audio/video signal to the second display module and the different second audio/video signal to the first display module. Controlling the vibrating elements may comprise transition generating of sound from the first display module to the second display module as an image moves from the first display element to the second display element. Controlling the vibrating elements may comprise the controller providing stereo widening where audio corresponding to an image in a middle of the at least one display element is played on at least one different one of the vibrating elements proximate an edge of the at least one display element.

In one example embodiment a non-transitory program storage device readable by a machine may be provided, tangibly embodying a program of instructions executable by the machine for performing operations, the operations comprising generating a first sound from a first speaker, where the first sound is generated by a first vibrating element at least partially moving a first display element of at least one display element; and generating a second sound from a second speaker, where the second sound is generated by a second vibrating element at least partially moving the first display element or a second display element of the at least one display element, where the first sound and the second sound are at least partially independently generated,

It does not matter how the display arrangement is configured in an apparatus (separate display components or a single module comprising separate components). The display element could be either a display module itself or a display window in front of the display module or both. The vibrating elements (piezo actuators) can be mechanically and suitably coupled to either controllable section. It is understood that both the visual data and audio data can be controlled. Such displayed image/visual data can be the same or different. In a similar way each speaker (display) can reproduce same or different sounds. The distinction is that each speaker (display) may be independently controllable which effectively means each display element is controllable.

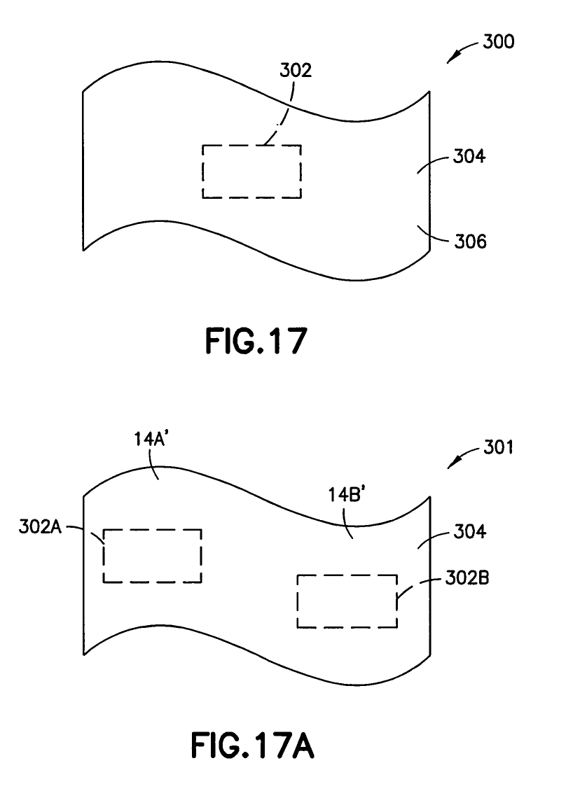

Referring also to FIG. 17, features as described herein are not limited to use with a rigid display element. FIG. 17 shows a speaker 300 comprising a vibrating element 302 and a flexible display element 304. The flexible display element 304 is configured to electronically display images. The vibrating element 302 is connected to the flexible display element 301 to cause the flexible display element 301 to move or vibrate to thereby generate sound waves from the front 306 of the flexible display element 304. Thus, principals may be applied also if there is a dual display device implemented with one physical monolithic display element that bends. Despite being one display element, the full display stack may be separated for both areas and, thus, there could be two separate panel speakers.

Referring also to FIG. 17A, a device 301 is shown comprising the flexible display element 304 and two of the vibrating elements 302A, 302B. Speakers 14A′ and 14B′ are of the same display component 304, but both areas driven by their respective vibrating elements 302A, 302B making them separate speakers. Thus, FIG. 17A illustrates at least two speakers 14A′, 14B′, where each speaker comprises at least one vibrating element 302A, 302B and one or more display elements 304. Here we have a case where we have two speakers, both comprising at least one vibrating element, but each speaker 14A′, 14B′ may only use half of a display element 304 (or other percentage less than a whole).

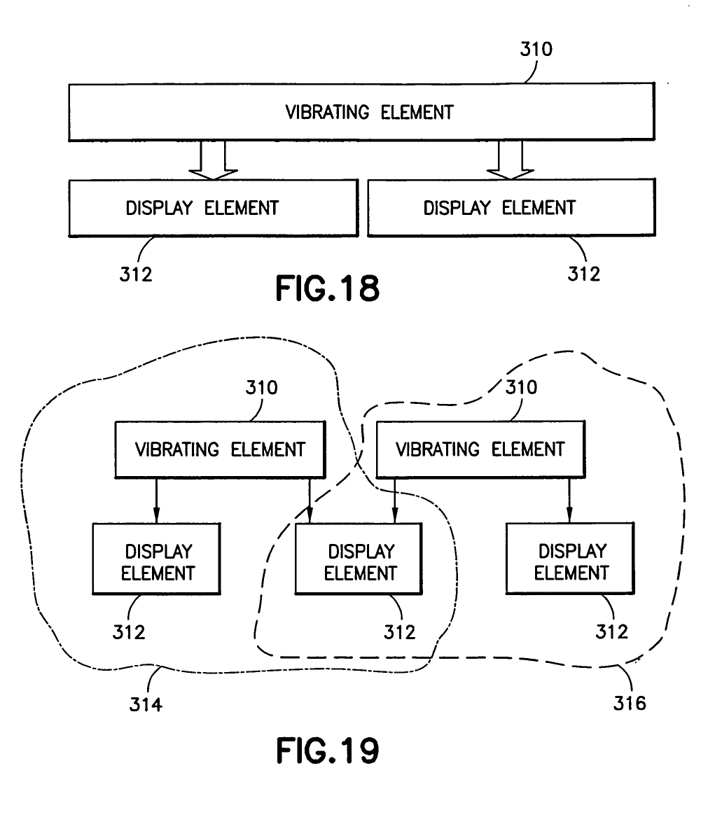

Referring also to FIG. 18, another example embodiment is shown where one vibrating element 310 is connected to more than one display element 312. Thus, one vibrating element 310 may be used to generate sound from more than one display element 312.

Referring also to FIG. 19, another example embodiment is shown where groups, such as 314 and 316, of the vibrating elements and display elements may be provided. In addition one display element 312 may be connected to more than one vibrating element 310. It is possible to design a display structure (like a matrix) where one piezo can drive a group of display modules and a second piezo can drive another plurality of display modules. Such display arrangement can be provided in such a way that the user will not see any discontinuity (or substantial discontinuity) between said pluralities of display modules, but such internal mechanic arrangement can be provided with discontinuity. Each speaker can be driven independently (both audio and visual), but a piezo can be assigned to a group of displays.

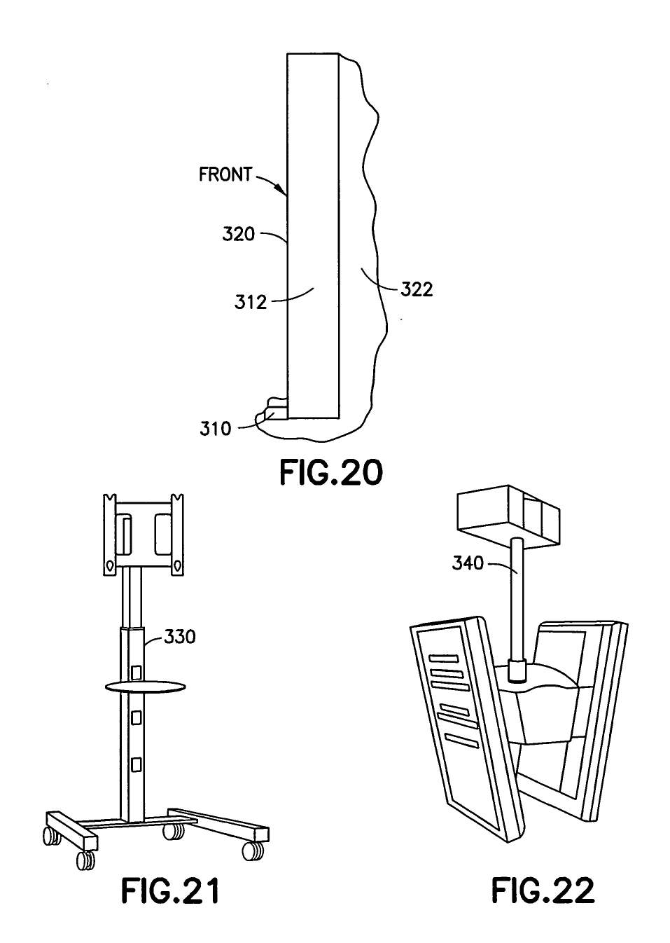

Referring also to FIG. 20, another example embodiment is shown where the vibrating element 310 is located on the front side 320 of the display element 312 inside a housing 322 which partially covers the an edge of the display element 312. It is possible that a piezo component can couple and vibrate the display window in front of the display. Therefore, the display element could be the display itself or a display window in front.

We can also have loudness control by using multiple displays. If we have e.g. telephony use case where audio is mono audio, we can control loudness also by selecting how many displays will play that mono audio.

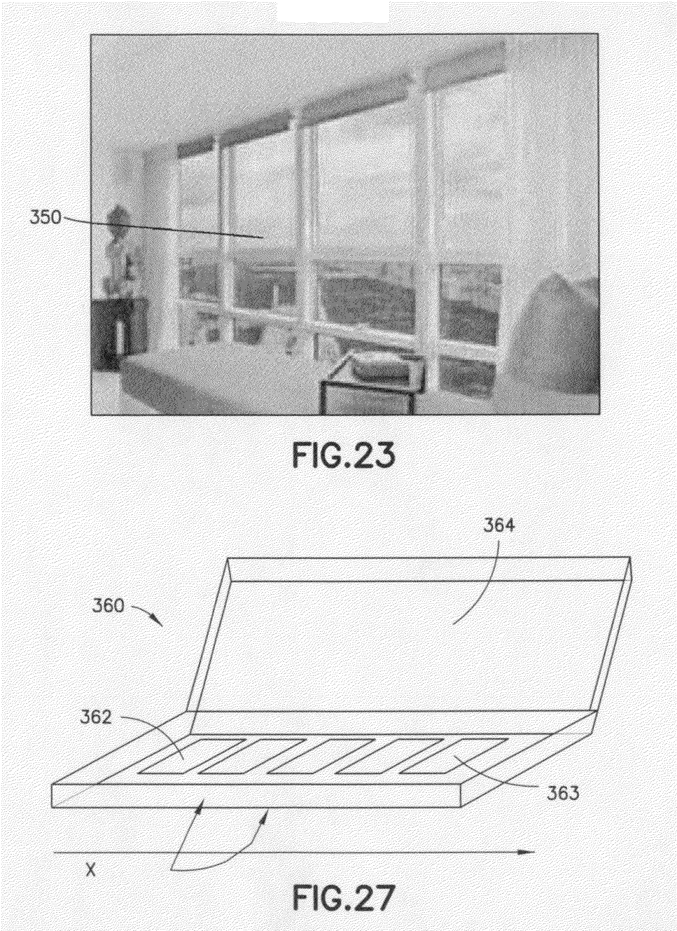

Referring also to FIGS. 21 and 22, in other example embodiments the speaker could be mounted to a stand 330 or hung by a suspension 340. As illustrated by FIG. 23, features as described herein may be integrated into a window 350. Basically the windows of a room could work as panel speakers. There are some transparent or semi-transparent display technologies. So the window could work as a normal window when the display is switched OFF, and as a display when it is switched ON. Then, they could be driven by some actuators to produce sound. So the use case is the same as audio displays hanging in the wall of a room, Put use the windows as the displays.

Referring also to FIG. 27, another example embodiment is shown. If we have a dual display Tactile Audio Display device 360 where one audio display module 362 is meant mainly to have a user interface (UI) functionality (such as a virtual keyboard 363 for example) and, thus, tactile or haptic button feedback, and the other audio display module 364 is meant mainly for example for media consumption (images and sound), then we have a device 360 where the feedback sound for button presses come directly from the virtual keyboard 363 while the media consumption comes directly from the direction where the media is consumed (from the audio display module 364). Benefits over conventional speakers includes a more astectically pleasing and easier to integrate device. If the same would be implemented using conventional speakers, then the speakers in both parts should be in the middle of the device in x-axis (either in the side or behind as the green arrows indicate) and that would be ugly and/or difficult integration.

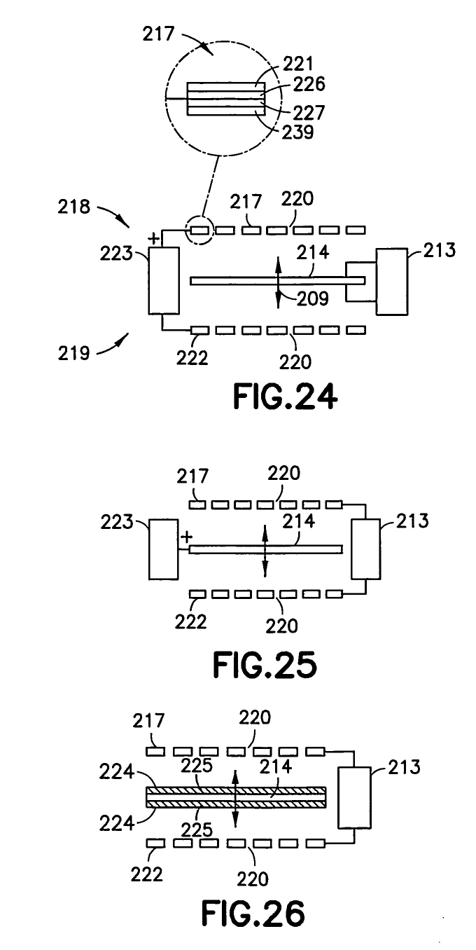

Referring also to FIG. 24, a cross sectional view of a configuration is shown which may be provided in one of the audio display modules 14. The display region comprises a display element 214. The display element 214 (which in some embodiments can be known as the display face) may be configured to display visual content to the user positioned in front of the apparatus. The display element 214 may be positioned behind a stationary part 217 which forms part of the display region. The display element 214 may be any suitable display technology such as, for example, liquid crystal display (LCD), organic LED (OLED) display, inorganic LED display, electrochromic display, electrophoretic display, or electrowetting display.

The display stationary part 217 may be a cover screen configured to protect the display element 214 from physical damage. For example the stationary part 217 may be configured to protect the electronic display 214 from direct touch or other external forces. For simplicity the display element 214 is shown as a single layer. However, it would be understood that in some embodiments the display element 214 could be more than one layer. Furthermore, in some embodiments there may be additional components (not shown) between the display element 214 and the stationary part 217 (for example additional layers of material). A similar display is described in International Application No. PCT/IB2010/056150 (International Publication No. WO 2012/090032 A1), which is hereby incorporated by reference in its entirety.

The display element 214 may be configured to operate as a speaker diaphragm and vibrate with respect to the stationary part 217. The vibration of the display element 214 may, therefore, displace air adjacent to the plane of the display element 214 resulting in the generation of sound waves in front 218 and behind 219 the display element 214. To allow a user to hear the sound waves in this example, the stationary part 217 is configured to be substantially acoustically transparent. Furthermore, to enable the user to view the visual content shown on the display element 214, the stationary part 217 may be configured to be at least partially substantially optically transparent. The stationary part 217, being stationary, is configured not to vibrate. This may reduce the problem of changing light reflections on the display element where reflections from the display element 214 when vibrating can distract the user and have a negative influence on the quality of the displayed image.

The stationary part 217 may comprise a lattice structure. In other words, the stationary part 217 may be configured to comprise at least one aperture or hole 220. The dimensions of each aperture 220 may be designed such that each aperture 220 is substantially invisible to the naked eye. The dimensions of each aperture 220 may be chosen to minimize accumulation within each aperture 220 of contaminants such as for example dirt, skin, dust, moisture or oil. A suitable dimension for each aperture may be an aperture diameter less than 0.05 mm so that they are difficult to see or cannot be seen by the user (and therefore do not detract from the visual content of the display element 214), and do not get contaminated and therefore blocked by particles or fluids. This may be smaller than the pixel diameter of most modern displays. To further reduce the accumulation of foreign particles and fluids within the aperture 220, the stationary part 217 may comprise a coating 221 to help repel particles and fluids. In some embodiments the coating 221 may be a self-cleaning coating.

The coating 221 in some embodiments can be at least one of a hydrophobic coating, oleophilic coating, and a scratch resistant coating. For example, the coating 221 can in some embodiments comprise a self-cleaning coating for a glass layer which is configured to prevent the build-up of dirt through photocatalytic decomposition. The self-cleaning coating can in some embodiments comprise glass containing titanium dioxide. Examples of commercially available self-cleaning glass (which may be suitable for use with the present apparatus) include: Pilkington ACTIV™ by Pilkington, SUNCLEAN™ by PPG Industries, Neat Glass™ by Cardinal Glass Industries, SGG AQUACLEAN™ by Saint-Gobain, and BIOCLEAN™ by Saint-Gobain. Another example of a commercially available coating which may be suitable for use with the present apparatus is DFI™ by Diamond Fusion International, Inc.

The aperture 220 dimension may be chosen or designed to enable a tuning of the acoustic resistance of the stationary part 217. In some embodiments a suitable selection or design using a determined number of apertures 220, and with determined aperture 220 dimensions, it is possible to control the vibration modes of the display element 214.

The display element 214 may be moved or vibrated using any suitable actuator. For example in some embodiments the display element 214 may be considered to be a diaphragm element in an electrodynamic setup such as used by conventional loudspeakers. In some embodiments one or more actuator may be used to vibrate the display 214. The actuator used to move the display element may be any suitable actuator technology such as pneumatic, hydraulic, electric, magnetic or piezoelectric. Furthermore, in some example embodiments the actuator may be configured to convert an electrical signal into a linear motion of the display element and, thus, enable an audio driver 213 to receive an audio signal and drive the display element 214. The actuator may be part of the display element. For example the display element 214 may be a flexible display and generate bending waves using one or more exciters, in a manner similar to a distributed mode loudspeaker.

The display element may be actuated to be both a display and an acoustic transducer. It should be understood that in some embodiments the integrated display and acoustic transducer layer may further incorporate a touch interface layer configured to enable inputs to the device which can be interoperated and used to control parameters associated with the displayed image and/or the acoustical properties of the integrated display and acoustic transducer layer. Thus, a touch layer, to provide touch screen functionality, may be implemented over and integral with the display embodiments.

In some embodiments, such as shown in FIG. 24 an electrostatic charge can be configured to induce vibrations in the display element 214 and, thus, generate the acoustic waves. By use of an electrostatic charge vibration generation, the number of moving parts in the speaker can be reduced. As with all speaker modules, the sound waves generated by the display element can cause mechanical vibration of all objects the sound or acoustic waves interact with. This can include all parts of the speaker module and any electronic components. By reducing the number of moving parts the audio degradation caused when the amplitude of these vibrations is sufficient can be reduced, resulting in a more faithful reproduction of the recorded signal.

In some embodiments the apparatus further comprises a second stationary part 222 positioned behind the display element 214. As shown in FIGS. 24-26, in some embodiments there may be additional components located between the display 214 and the second stationary part 222 (for example additional layers of material). The second stationary part 222 may, like the stationary part 217 in front of the display element 214, be substantially acoustically transparent and configured such that the sound waves generated behind or at the rear 219 of the vibrating display element 214 can radiate through the second stationary part 222.

In some embodiments, and unlike the stationary part 217, the second stationary part 222 may be optically opaque or solid; as the second stationary part 222 is not used for display purposes. The second stationary part 222 may comprise at least one aperture 220. The dimensions and/or number of apertures 220 may be determined by the acoustic qualities only and need not be dictated by the same optical requirements that affect the apertures 220 of the stationary part 217.

As shown in FIG. 26, the display element 214 may comprise two porous electret membranes 224, one located on either side of the display element 214, to store electrical charge. Each electret membrane 224 may comprise an optically transparent conductive coating 225, such as for example indium oxide, on the face adjacent to the display 214. For low distortion operation, the display 214 may have a constant charge on its surfaces. The conductive coatings 225 of the electret membranes 224, which are in physical contact with the display 214 may assist in achieving a constant or relatively uniform charge density by increasing the surface resistivity of the display 214.

Where the electrets layers 224 have the same polarity, the display may be driven by varying the polarity or/and the magnitude of charge of the stationary part 217 and the second stationary part 222. The use of an electret display element 214 operating as a loudspeaker has in some embodiments the advantage of being highly efficient, exhibiting low distortion, and providing a flat frequency response. In addition, the absence of a magnet reduces the volume required for the loudspeaker and assists in reducing or eliminating other issues such as disturbing RF circuitry or erasing information stored in magnetic storage media.

In some embodiments the stationary part 217 (and in some embodiments the second stationary part 222) may comprise touch screen technology configured to allow a user to interact directly with content shown on the display element 214 by touching the stationary part 217 above the display element 214. In some embodiments the stationary part can comprise at least one touch sensitive element 226 such as for example the touch sensitive element layer 226 of the stationary part 217 seen in the enlarged view section of FIG. 24.

In some embodiments the stationary part 217 and the additional stationary part 222 may comprise haptic technology configured to provide tactile feedback to a user when the user touches the stationary part 217 (or the second stationary part 222). The haptic technology may employ, for example, one or more of pneumatic stimulation, vibro-tactile stimulation, electrotactile stimulation, and functional neuromuscular stimulation. Thus, for example, the stationary part 217 may comprise a haptic element 227 as seen in the enlarged view of FIG. 24. Each of the stationary part 217 and the second stationary part 222 can in some embodiments comprise an electrically conducting layer 239. Where both the stationary part 217 and the second stationary part 222 are acoustically transparent, sound or acoustic waves are able to radiate in both the front 218 and rear 219 directions. As a result of this symmetry, the display element ‘speaker’ 214 is configured to produce a dipole radiation pattern. However, in alternate examples, a dipole radiation pattern might not be provided.

In one type of example embodiment, an apparatus comprises at least two speakers, where each speaker comprises at least one vibrating element and one or more display elements, where the vibrating elements are configured to at least partially move the one or more display elements to generate sound waves from the one or more display elements; and at least one controller connected to the vibrating elements and the one or more display elements of the at least two speakers, where the at least one controller is configured to control display of at least one image on the one or more display elements and/or control driving of the vibrating elements to generate sounds from at least one of the at least two speakers.

The at least two speakers may comprise at least two display modules, where each display module comprises a separate one of the display elements, and where each of the display modules comprise a separate one of the vibrating elements in each of the display modules. There could be at least two speakers, and each speaker can be independently functional both in sound and visual. In alternative embodiments, both displays could be controlled the same (i.e. no independency). The at least one controller may be configured to send a first audio/video signal (a signal(s) comprising both an audio component and a video component) to a first one of the speakers and a different second audio/video signal to a second one of the speakers.

The term ‘move’ may include ‘actuate’ for example. There could be more than one controller, such as one for the vibrating element(s) and one for the display element(s), or alternatively some kind of interaction between multiple controllers. The controller could be defined as a ‘processor’ in alternative embodiments. In some cases it may not be necessary to control vibrating elements if there is no intention for sound generation or haptic feedback. Features as described herein include providing a functionality of an haptic feedback. In some use cases it may be sufficient to actuate display using one piezo only. Therefore, it may not be necessary to generate sounds from the two speakers. The apparatus may comprise means for providing at least one of a mono sound generation based on the at least two speakers, and a non-mono sound generation based on the at least two speakers. For example, a ‘mono’ may comprise both speakers generating the same sound, which could increase loudness due to mutual acoustic coupling, and a ‘non-mono’ may comprise a stereo widening effect or directionality based on the two speakers where the two speakers could generate the same sound with spatial audio algorithms or 3D audio consideration. Alternatively, the two speakers can generate different sounds.

The two speakers could be provided inside a same apparatus. That apparatus could be foldable or bendable where the speakers could be formed in such a way that no-discontinuity (or minor discontinuity) is visible to the user. In alternative embodiments, such discontinuity could be visible though.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least two speakers, where each speaker comprises at least one vibrating element and one or more display elements, where the vibrating elements are configured to at least partially move the one or more display elements to generate sound waves from the one or more display elements; and
at least one controller connected to the vibrating elements and the one or more display elements of the at least two speakers, where the at least one controller is configured to control display of at least one image on the one or more display elements and/or control driving of the vibrating elements to generate sounds from at least one of the at least two speakers.

2. An apparatus as in claim 1 where the at least two speakers comprise at least two display modules, where each display module comprises a separate one of the display elements, and where each of the display modules comprise a separate one of the vibrating elements in each of the display modules.

3. An apparatus as in claim 1 where the apparatus is a portable electronic equipment having the at least two speakers, where the one or more display elements at least partially form a display of the portable electronic equipment.

4. An apparatus as in claim 2 where the apparatus comprises a frame having a first section with a first one of one speakers and a second section with a second one of the speakers, and where the first section is movably connected to the second section.

5. An apparatus as in claim 1 where the at least two speakers comprise at least two display modules which are configured to be separately connected to a wall of a room.

6. An apparatus as in claim 5 where the at least two display modules are configured to be separately connected to at least two different walls of the room or at least one wall and a ceiling of the room.

7. An apparatus as in claim 1 where the at least two speakers comprise at least two display modules which are configured to be connected adjacent each other to a wall of a room.

8. An apparatus as in claim 1 where the vibrating element of each of the speakers is a vibrating element of a respective display module.

9. An apparatus as in claim 2 where the at least one controller is configured to change an incoming audio signal into different audio signals sent to the respective different vibrating elements based upon the different images displayed on the respective display elements.

10. An apparatus as in claim 1 where the at least one controller is configured to send a first channel of a multi-channel audio signal to a first one of the vibrating elements and to send a second channel of the multi-channel audio signal to a second one of the vibrating elements, where the first display module only receives the first channel and the second display module only receives the second channel.

11. An apparatus as in claim 1 where the at least one controller is configured to send a first audio/video signal to a first one of the speakers and a different second audio/video signal to a second one of the speakers.

12. An apparatus as in claim 11 where the at least one controller is configured to switch sending of the first audio/video signal to the second speaker and the different second audio/video signal to the first speaker.

13. An apparatus as in claim 1 where the at least one controller is configured to transition generating of sound from a first one of the speakers to a second one of the speakers as an image moves from the display element at the first speaker to the display element at the second speaker.

14. An apparatus as in claim 1 where the at least two speakers comprise middle ones of the speakers and edge ones of the speakers on opposite sides of the middle ones, where the at least one controller is configured to provide stereo widening where audio corresponding to an image at the display element proximate the middle ones is played on the edge ones of the speakers.

15. An apparatus as in claim 1 comprising means for providing at least one of:
a mono sound generation based on the at least two speakers,
a non-mono sound generation based on the at least two speakers.

16. A method comprising:
generating a first sound from a first speaker, where the first sound is generated by a first vibrating element at least partially moving a first display element of at least one display element;
generating a second sound from a second speaker, where the second sound is generated by a second vibrating element at least partially moving the first display element or a second display element of the at least one display element; and
controlling the vibrating elements such that the first sound and the second sound are generated.

17. A method as in claim 16 where controlling the vibrating elements comprises changing an incoming audio signal into different audio signals sent to the respective vibrating elements based upon different images displayed on the at least one display element proximate the respective vibrating element.

18. A method as in claim 16 where controlling the vibrating elements comprises sending a first channel of a multi-channel audio signal to a first one of the vibrating elements and sending a second channel of the multi-channel audio signal to a second one of vibrating elements, where the first vibrating element only receives the first channel and the second vibrating element only receives the second channel.

19. A method as in claim 16 where controlling the vibrating elements comprises sending a first audio/video signal to a first display module comprising the first vibrating element and the first display element and a different second audio/video signal to a second display module comprising the second vibrating element and the second display element.

20. A method as in claim 19 where controlling the vibrating elements comprises switching sending of the first audio/video signal to the second display module and the different second audio/video signal to the first display module.

21. A method as in claim 19 where controlling the vibrating elements comprises transition generating of sound from the first display module to the second display module as an image moves from the first display element to the second display element.

22. A method as in claim 16 where controlling the vibrating elements comprises at least one controller providing stereo widening where audio corresponding to an image in a middle of the at least one display element is played on at least one different one of the vibrating elements proximate an edge of the at least one display element.

23. A non-transitory program storage device readable by a machine, tangibly embodying a program of instructions executable by the machine for performing operations, the operations comprising:
generating a first sound from a first speaker, where the first sound is generated by a first vibrating element at least partially moving a first display element of at least one display element; and
generating a second sound from a second speaker, where the second sound is generated by a second vibrating element at least partially moving the first display element or a second display element of the at least one display element, where the first sound and the second sound are generated.
